(19) United States
(12) Patent Application Publication
(10) Pub. No.: US 2009/0132334 A1
(43) Pub. Date: May 21, 2009

(54) System and Method for Estimating an Amount of Traffic Associated with a Digital Advertisement

(75) Inventors: Xuerui Wang, Amherst, MA (US); Marcus Fontoura, Mountain View, CA (US); Vanja Josifovski, Los Gatos, CA (US); Andrei Broder, Menlo Park, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/942,153

(22) Filed: Nov. 19, 2007

(51) Int. Cl. G06Q 30/00; G06Q 10/00

(52) U.S. Cl. 705/10

(57) ABSTRACT

Systems and methods for estimating an amount of traffic associated with a digital ad are disclosed. Generally, a forecasting module identifies a set of candidate webpages on which a digital ad may be displayed and estimates a click through rate associated with the digital ad and a webpage of the set of candidate webpages. The forecasting module determines a ranking score associated with the digital ad based on the determined click through rate and a bid price associated with the digital ad. The forecasting module then examines historical data, such as search logs, to determine an estimate of traffic associated with the digital ad with respect to the webpage in response to determining the ranking score of the digital ad exceeds a ranking score associated with another digital ad that was previously displayed on the webpage.

### BACKGROUND

Online advertising has become a significant source of income for many Internet companies such as Yahoo! Inc. (www.yahoo.com). Internet advertising delivery companies (“ad providers”) typically sell webpage advertisement placements for the placement of digital ads in terms of either guaranteed deliveries or non-guaranteed deliveries. With respect to guaranteed deliveries, an ad provider guarantees to serve a set number of digital ads, which are typically graphical ads, for a determined fee. With respect to non-guaranteed deliveries, an ad provider does not guarantee to serve a set number of digital ads. But when the ad provider does serve a digital ad, an advertiser agrees to compensate the ad provider a defined amount based on an action associated with the served digital ad. For example, the ad provider may be compensated for each impression associated with a digital ad, for each click-through (“click”) associated with a digital ad, or for each transaction associated with a digital ad.

When an ad provider serves a non-guaranteed digital ad, the ad provider generally determines which non-guaranteed digital ad to serve based at least in part on a bid price associated with a digital ad and a degree of relevance between the digital ad and a webpage and/or a search query. A bid price is the amount of compensation an advertiser agrees to provide an ad provider based on an action associated with the served digital ad.

Ad providers often provide tools to estimate a future performance of a non-guaranteed digital ad based on different bid prices. Traditionally, ad providers estimate the future performance of a non-guaranteed digital ad by running an ad campaign including the digital ad for a test period at no cost to an advertiser, and extrapolating the observed performance of the digital ad during the test period Advertisers desire tools to estimate the performance of a non-guaranteed digital ad more quickly, and ad providers desire tools to predict the performance of a non-guaranteed digital ad without running an ad campaign including the digital ad for a test period at no cost to an advertiser.

### BRIEF DESCRIPTION OF THE DRAWINGS

FIG. 1 is a block diagram of an environment in which a system for estimating an amount of traffic associated with a digital ad may operate;

FIG. 2 is a block diagram of a system for estimating an amount of traffic associated with a digital ad; and

FIG. 3 is a flow chart of a method for estimating an amount of traffic associated with a digital ad.

### DETAILED DESCRIPTION OF THE DRAWINGS

The present disclosure is directed to systems and methods for estimating an amount of traffic associated with a digital ad. The systems and methods described below provide the ability to estimate an amount of traffic associated with a digital ad by examining the historical performance of other digital ads on webpages where the digital ad would likely be displayed. Estimating an amount of traffic based on the historical performance of digital ads on webpages rather than running an ad campaign including the digital ad for a test period provides an ad provider the ability to provide estimates of traffic associated with a digital ad to an advertiser in substantially real time and to determine an estimate of traffic associated with a digital ad without running an ad campaign including the digital ad for a test period at no cost to an advertiser.

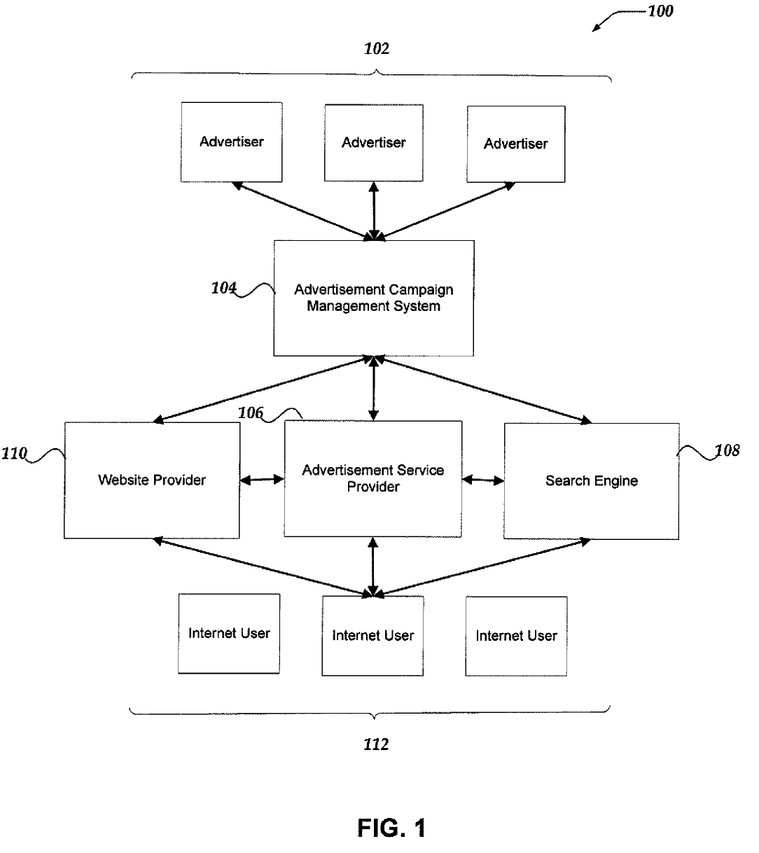

FIG. 1 is a block diagram of an environment in which a system for estimating an amount of traffic associated with a digital ad may operate. For explanation purposes, the environment is described with respect to a search engine for pay-for-placement online advertising. However, it should be appreciated that the systems and methods described below are not limited to use with a search engine or pay-for-placement online advertising.

The environment 100 may include a plurality of advertisers 102, an ad campaign management system 104, an ad provider 106, a search engine 108, a website provider 110, and a plurality of Internet users 112. Generally, an advertiser 102 bids on terms and creates one or more digital ads by interacting with the ad campaign management system 104 in communication with the ad provider 106. The advertisers 102 may purchase digital ads based on an auction model of buying ad space (a non-guaranteed delivery model) or a guaranteed delivery model by which an advertiser pays a minimum cost-per-thousand impressions (i.e., CPM) to display the digital ad. Typically, the advertisers 102 may pay additional premiums for certain targeting options, such as targeting by demographics, geography, technographics or context. The digital ad may be a graphical banner ad that appears on a website viewed by Internet users 112, a sponsored search listing that is served to an Internet user 112 in response to a search performed at a search engine, a video ad, a graphical banner ad based on a sponsored search listing, and/or any other type of online marketing media known in the art.

When an Internet user 112 performs a search at a search engine 108, the search engine 108 may return a plurality of search listings to the Internet user. The ad provider 106 may additionally serve one or more digital ads to the Internet user 112 based on search terms provided by the Internet user 112. In addition or alternatively, when an Internet user 112 views a website served by the website provider 110, the ad provider 106 may serve one or more digital ads to the Internet user 112 based on keywords obtained from the content of the website.

When the search listings and digital ads are served, the ad campaign management system 104, the ad provider 106, and/or the search engine 108 may record and process information associated with the served search listings and digital ads for purposes such as billing, reporting, or ad campaign optimization. For example, the ad campaign management system 104, ad provider 1061 and/or search engine 108 may record the search terms that caused the search engine 108 to serve the search listings; the search terms that caused the ad provider 106 to serve the digital ads; whether the Internet user 112 clicked on a URL associated with one of the search listings or digital ads; what additional search listings or digital ads were served with each search listing or each digital ad; a rank of a search listing when the Internet user 112 clicked on the search listing; a rank or position of a digital ad when the Internet user 112 clicked on a digital ad; and/or whether the Internet user 112 clicked on a different search listing or digital ad when a digital ad, or a search listing, was served. One example of an ad campaign management system that may perform these types of actions is disclosed in U.S. patent application Ser. No. 11/413,514, filed Apr. 28, 2006, and assigned to Yahoo! Inc., the entirety of which is hereby incorporated by reference. The systems described below for estimating an amount of traffic associated with a digital ad may operate in the environment of FIG. 1.

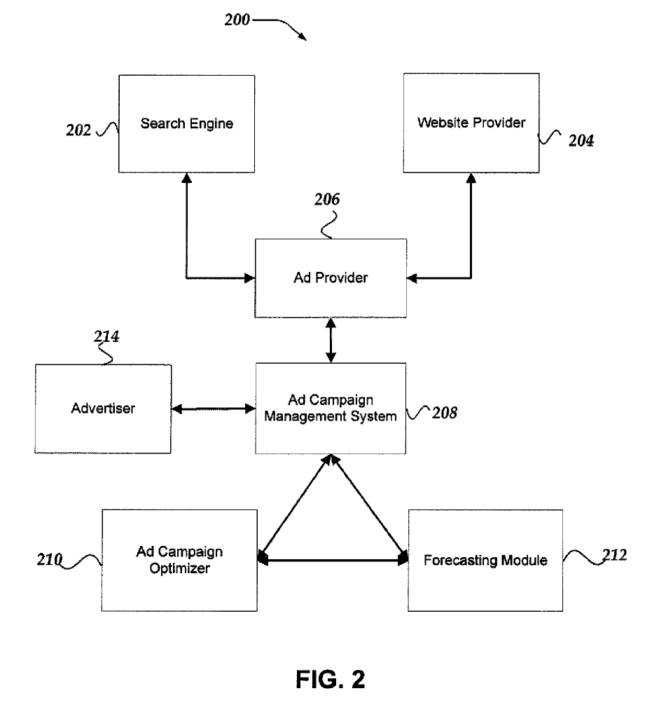

FIG. 2 is a block diagram of one embodiment of a system for estimating an amount of traffic associated with a digital ad. Generally, the system 200 includes a search engine 202, a website provider 204, an ad provider 206, an ad campaign management system 208, an ad campaign optimizer 210, and a forecasting module 212. In some implementations, the forecasting module 212 may be part of the search engine 202, website provider 204, ad provider 206, ad campaign management system 208, and/or ad campaign optimizer 210. However, in other implementations, the forecasting module 212 is distinct from the search engine 202, website provider 204, ad provider 206, ad campaign management system 208, and/or ad campaign optimizer 210.

The search engine 202, website provider 204, ad provider 206, ad campaign management system 208, ad campaign optimizer 210, and forecasting module 212 may communicate with each other over one or more external or internal networks. The networks may include local area networks (LAN), wide area networks (WAN), and the Internet, and may be implemented with wireless or wired communication such as wireless fidelity (WiFi), Bluetooth, landlines, satellites, and/or cellular communications. Further, the search engine 202, website provider 204, ad provider 206, ad campaign management system 208, ad campaign optimizer 210, and forecasting module 212 may be implemented as software code running in conjunction with a processor such as a single server, a plurality of servers, or any other type of computing device known in the art.

Generally, an advertiser 214 interacts with the ad campaign management system 208 to create a digital ad. The digital ad may be a graphical banner ad, a sponsored search listing, a video ad, a graphical ad based on a textual offer, and/or any other type of online marketing media. The advertiser 214 may set a bid price at an ad campaign level, an ad group level, or a digital ad level. Additionally or alternatively, the advertiser 214 may request the ad campaign optimizer 210 to set a bid price at an ad campaign level, an ad group level, or a digital ad level based on business objectives set by the advertiser. Examples of ad campaign optimizers 210 are disclosed in U.S. Pat. No. 7,231,358, filed Feb. 8, 2002 and assigned to Overture Services, Inc., and U.S. patent application Ser. No. 11/607,292, filed Nov. 30, 2006 and assigned to Yahoo! Inc., the entirety of which is hereby incorporated by reference. When determining a bid price for digital ads, the ad campaign optimizer 210 and/or the advertiser 214 may request from the forecasting module 212 an estimate of a number of expected potential customers that will interact with the digital ads based on the bid price, also known as an amount of traffic associated with the digital ads.

The ad campaign optimizer 210 and/or advertiser 214 may request an estimate of an amount of traffic associated with digital ads for many reasons. For example, the ad campaign optimizer 210 and/or advertiser 214 may desire to determine quickly and accurately, given a group of digital ads associated with the same bid price, which digital ad results in the most click-throughs or conversions. Alternatively or in addition, the ad campaign optimizer 210 and/or advertiser 214 may desire to determine how much the ad campaign optimizer 210 and/or advertiser 214 would need to increase a bid price of a digital ad to significantly increase an amount of traffic associated with the digital ad, or how much the ad campaign optimizer 210 and/or advertiser 214 could reduce a bid price associated with a digital ad while substantially maintaining a given amount of traffic associated with the digital ad.

In response to the request, the forecasting module 212 estimates an amount of traffic associated with the ad campaign, ad group, or digital ad based on the bid price. As explained in more detail below, the forecasting module 210 estimates an amount of traffic associated with a digital ad based on a ranking score associated with the digital ad and a historical performance of other digital ads on a set of webpages. A ranking score of a digital ad is a value representative of a likelihood that the digital ad will be displayed on a specific webpage. In one implementation, a ranking score of a digital ad with respect to a webpage is calculated as a product of a bid price associated with the digital ad and a click-through rate associated with the digital ad with respect to the webpage.

Typically, when the ad campaign optimizer 210 and/or advertiser 214 requests an estimate of an amount of traffic at an ad campaign level or an ad group level, the forecasting module 212 determines an amount of traffic associated with each digital ad in the ad campaign or the ad group, and then aggregates the amount of traffic associated with each digital ad to determine a total estimate of an amount of traffic at the ad campaign level or the ad group level.

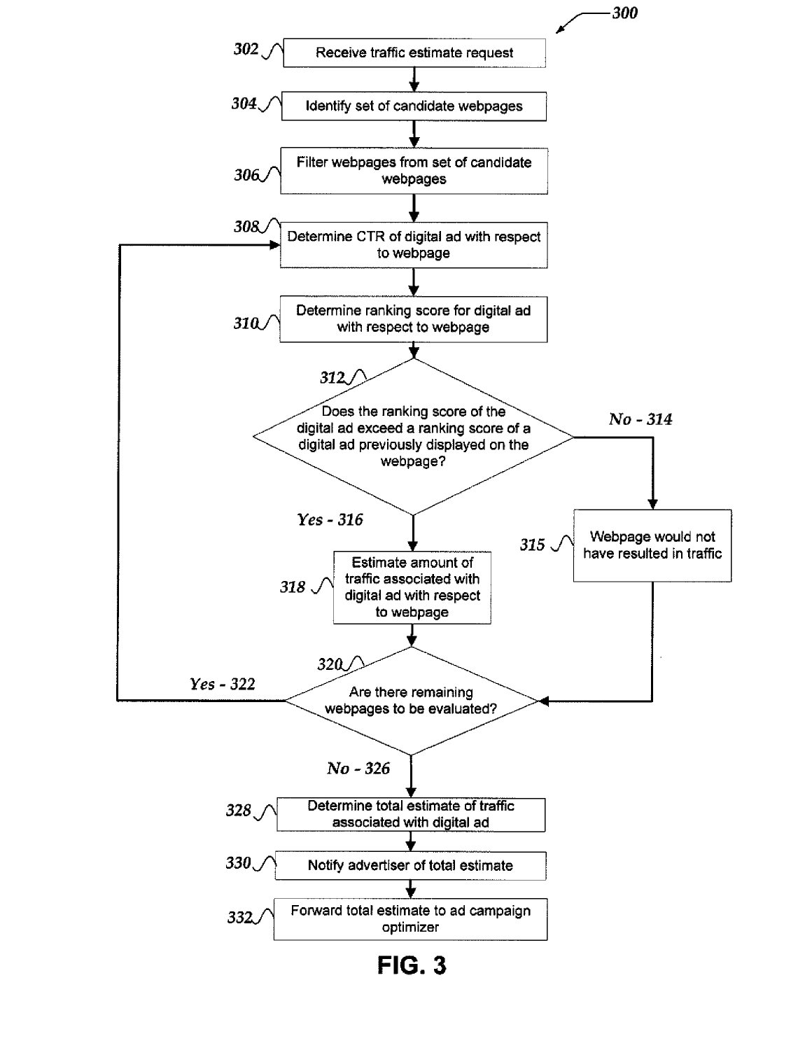

FIG. 3 is a flow chart of one embodiment of a method for estimating an amount of traffic associated with a digital ad. The method 300 begins at step 302 with an ad campaign management system receiving a request to estimate an amount of traffic associated with a digital ad and a bid price. At step 304, the forecasting module examines historical data, such as search logs, to identify a set of candidate webpages on which the digital ad potentially could have been displayed. In one implementation, the forecasting module determines whether a digital ad could have been displayed on a webpage based on a keyword associated with the digital ad and whether the keyword, or a term semantically related to the keyword, is associated with the webpage. For example, a keyword may be associated with a webpage if the keyword, or a term semantically related to the keyword, is present in the content of the webpage. Similarly, a keyword may be associated with a webpage if an Internet user performing a search at an Internet search engine for the keyword, or a term semantically related to the keyword, would result in the Internet search engine serving a search listing associated with the webpage to the Internet user.

In some implementations, at step 306, the forecasting module may additionally calculate a degree of relevance between the digital ad and each webpage of the set of candidate webpages, and filter certain webpages from the set of webpages based on the calculated degree of relevance between the digital ad and a webpage of the set of candidate webpages. The forecasting module may calculate a degree of relevance between a digital ad and a webpage based on factors such as a location of a keyword in the content of the webpage, a location of a term semantically related to the keyword in the content of the webpage, a degree of a semantical relationship between a term present in the content of the webpage and a keyword, and a ranking of a search listing associated with the webpage in search results served to an Internet user in response to a search query including the keyword, or a term semantically related to the keyword.

At step 308, the forecasting module estimates a click-through rate (“CTR”) of the digital ad with respect to a webpage of the set of candidate webpages identified at step 304. Typically, the forecasting module estimates a CTR of a digital ad with respect to a webpage based on a degree of similarity between the digital ad and the webpage through the user of standard IR techniques, such as term frequency-inverse document frequency (“TFIDF”) similarity. Examples of methods for estimating a CTR of a digital ad with respect to a webpage are disclosed in Deepak Agarwal, Andrei Z. Broder, Deepayan Chakrabarti, Dejan Diklic, Vanja Josifovski, and Mayssam Sayyadian: Estimating Rates of Rare Events at Multiple Resolutions, KDD 2007: 16-25.

At step 310, the forecasting module determines a ranking score associated with the digital ad with respect to the webpage. In one implementation, the forecasting module calculates the ranking score as a product of the CTR determined at step 308 and a bid price associated with the digital ad.

At step 312, the forecasting module examines historical data to determine whether the ranking score associated with the digital ad determined at step 310 is at least equal to a ranking score associated with at least one of the digital ads that was actually displayed on the webpage as evidenced in the historical data. In one implementation, a ranking score of a digital ad that was actually displayed on a webpage may be calculated as a product of the bid price of the digital ad when it was displayed on the webpage and a CTR of the digital ad with respect to the webpage. By determining whether the ranking score of the digital ad is greater than or equal to at least one of the digital ads that was actually displayed on the webpage, the forecasting module is estimating whether the digital ad would have been displayed on the webpage in the past.

In one implementation, the forecasting module determines whether a ranking score of a first digital ad is greater than or equal to a ranking score of a second digital ad that was actually displayed on the webpage, where the second digital ad is associated with the lowest ranking score of all the digital ads that were actually displayed on the webpage. However, in other implementations, the forecasting module determines whether a ranking score of a first digital ad is greater than a ranking score of a second digital ad that was actually displayed on the webpage, where the second digital ad is not associated with the lowest ranking score of all the digital ads that were actually displayed on the webpage.

If the forecasting module determines the ranking score associated with the digital ad is not at least equal to a ranking score associated with one of the digital ads that was actually displayed in the webpage (branch 314), the forecasting module determines that the webpage would not have resulted in any traffic for the advertisement at step 315 and the method proceeds to step 320.

However, if the forecasting module determines the ranking score associated with the digital ad is at least equal to a ranking score associated with one of the digital ads that was actually displayed in the webpage (branch 316), the forecasting module examines the historical data associated with the webpage to estimate an amount of traffic associated with the digital ad with respect to the webpage at step 318. In one implementation, the forecasting module estimates an amount of traffic associated with the digital ad with respect to the webpage based on a determined number of impressions of the digital ad on the webpage over a period of time as evidenced in the historical data and the click through rate associated with the digital ad determined at step 308. The method then proceeds to step 320.

At step 320, the forecasting module determines whether there are any webpages of the set of candidate webpages determined at step 306 that have not been evaluated. If the forecasting module determines there are remaining webpages of the set of candidate webpages to be evaluated (branch 322), the method loops to step 308 and the above-described process is repeated with respect to the next webpage of the set of candidate webpages. However, if the forecasting module determines there are no remaining webpages of the set of candidate webpages to be evaluated (branch 326), the method proceeds to step 328.

After each webpage of the set of candidate webpages has been evaluated, the forecasting module aggregates the resulting estimation of traffic associated with the digital ad and each evaluated webpage at step 328 to determine a total estimate of traffic associated with the digital ad. Additionally, the forecasting module may perform operations such as notifying an advertiser of the total estimated amount of traffic associated with a bid price of the digital ad at step 330 or forwarding the total estimate of traffic associated with a bid price of the digital ad to an ad campaign optimizer at step 332.

While the method described above has been described with respect to a single digital ad, it should be appreciated that to estimate an amount of traffic associated with an ad campaign or an ad group, the same method would be employed for each digital ad in the ad campaign or the ad group. The resulting estimates of traffic would then be aggregated to determine a total estimate of traffic associated with the ad campaign or the ad group.

For example, if an ad campaign included a first digital ad, a second digital ad, and a third digital ad, the above-described method would be repeated for each of the first, second, and third digital ads. The forecasting module would determine a first estimate of traffic associated the first digital ad, a second estimate of traffic associated with the second digital ad, and a third estimate of traffic associated with the third digital ad. The forecasting module would then aggregate the first, second, and third estimates of traffic to determine a total estimate of advertisement traffic associated with the ad campaign.

FIGS. 1-3 teach systems and methods for estimating an amount of traffic associated with a digital ad. The disclosed systems and methods provide the ability to estimate an amount of traffic associated with a digital ad by examining the historical performance of other digital ads on webpages where the digital ad would likely be displayed. Estimating an amount of traffic based on the historical performance of actual digital ads on webpages rather than running an ad campaign including the digital ad for a test period provides an ad provider the ability to provide estimates of traffic associated with a digital ad to an advertiser in substantially real time and to determine an estimate of traffic associated with a digital ad without running an ad campaign including the digital ad for a test period at no cost to an advertiser.

It is intended that the foregoing detailed description be regarded as illustrative rather than limiting, and that it be understood that it is the following claims, including all equivalents, that are intended to define the spirit and scope of this invention.

1. A method for estimating an amount of traffic associated with a digital ad, the method comprising the acts of:
identifying at least one candidate webpage on which a digital ad may be displayed;
estimating a first click through rate associated with the digital ad and a first webpage of the at least one candidate webpage;
determining a first ranking score associated with the digital ad based on the first click through rate and a bid price associated with the digital ad;
examining historical data to determine an estimate of traffic associated with the digital ad with respect to the first webpage in response to determining the first ranking score exceeds a ranking score associated with another digital ad that was previously displayed on the first webpage.

2. The method of claim 1, further comprising:
estimating a second click through rate associated with the digital ad and a second webpage of the at least one candidate webpage;
determining a second ranking score associated with the digital ad based on the second click through rate and the bid price associated with the digital ad;
examining historical data to determine an estimate of traffic associated with the digital ad with respect to the second webpage in response to determining the second ranking score exceeds a ranking score associated with another digital ad that was previously displayed on the second webpage; and
aggregating the estimate of traffic associated with the digital ad with respect to the first webpage and the estimate of traffic associated with the digital ad with respect to the second webpage.

3. The method of claim 1, wherein identifying at least one candidate webpage comprises:
determining a degree of relevance between the first webpage and the digital ad; and
comparing the determined degree of relevance between the first webpage and the digital ad with a threshold.

4. The method of claim 1, further comprising:
for each webpage of the at least one candidate webpage, determining a degree of relevance between the digital ad and the webpage; and
filtering at least one webpage from the at least one candidate webpage based on the determined degree of relevance associated with each webpage of the at least one candidate webpage.

5. The method of claim 1, wherein the digital ad is a graphical banner ad.

6. The method of claim 1, wherein the digital ad is a sponsored search listing.

7. The method of claim 1, wherein the digital ad is a graphical ad based on a sponsored search listing.

8. The method of claim 1, wherein determining a first ranking score comprises:
determining the first ranking score based on a product of the first click through rate and the bid price associated with the digital ad.

9. A computer-readable storage medium comprising a set of instructions for estimating an amount of traffic associated with a digital ad, the set of instructions to direct a processor to perform acts of:
estimating a first click through rate associated with a digital ad and a first webpage;
determining a first ranking score associated with the digital ad based on the first click through rate and a bid price associated with the digital ad; and
examining historical data to determine an estimate of an amount of traffic associated with the digital ad with respect to the first webpage in response to determining the first ranking score exceeds a ranking score associated with another digital ad that was previously displayed on the first webpage.

10. The computer-readable storage medium of claim 9, further comprising a set of instructions to direct a processor to perform acts of:
identifying at least one candidate webpage associated with the digital ad;
wherein the first webpage is a webpage of the at least one candidate webpage.

11. The computer-readable storage medium of claim 10, further comprising a set of instructions to direct a processor to perform acts of:
for each webpage of the at least one candidate webpage, determining a degree of relevance between the digital ad and the webpage; and
filtering at least one webpage from the at least one candidate webpage based on the determined degree of relevance associated with each webpage of the at least one candidate webpage.

12. The computer-readable storage medium of claim 10, further comprising a set of instructions to direct a processor to perform acts of:
estimating a second click through rate associated with the digital ad and a second webpage of the at least one candidate webpage;
determining a second ranking score associated with the digital ad based on the second click through rate and the bid price associated with the digital ad;
examining historical data to determine an estimate of traffic associated with the digital ad with respect to the second webpage in response to determining the second ranking score exceeds a ranking score associated with another digital ad that was previously displayed on the second webpage; and
aggregating the estimate of traffic associated with the digital ad with respect to the first webpage and the estimate of traffic associated with the digital ad with respect to the second webpage.

13. The computer-readable storage medium of claim 9, wherein determining a first ranking score comprises:
determining the first ranking score based on a product of the first click through rate and the bid price associated with the digital ad.

14. The computer-readable storage medium of claim 9, further comprising a set of instructions to direct a processor to perform acts of:
exporting the estimate of the amount of traffic associated with the digital ad to one of an ad campaign optimizer or an ad campaign management system.

15. A system for estimating an amount of traffic associated with a digital ad, the system comprising:
a forecasting module operative to identify at least one candidate webpage on which a digital ad may be displayed, to estimate a first click through rate associated with the digital ad and a first webpage of the at least one candidate webpage, to determine a first ranking score associated with the digital ad based on the first click through rate and a bid price associated width the digital ad, and to examine historical data to determine an estimate of an amount of traffic associated with the digital ad with respect to the first webpage in response to determining the first ranking score exceeds a ranking score associated with another digital ad that was previously displayed on the first webpage.

16. The system of claim 15, wherein the forecasting module is further operative to for each webpage of the at least one candidate webpage, determine a degree of relevance between the digital ad and the webpage, and to filter at least one webpage from the at least one candidate webpage based on the determined degree of relevance associated with each webpage of the at least one candidate webpage.

17. The system of claim 15, wherein the digital ad is one of a graphical banner ad, a sponsored search listing, or a graphical banner ad based on a sponsored search listing.

18. The system of claim 15, wherein the first ranking score is equal to a product of the first click through rate and the bid price associated with the digital ad.

19. The system of claim 15, wherein the forecasting module is further operative to export the estimate of the amount of traffic associated with the digital ad to one of an ad campaign optimizer or an ad campaign management system.

20. The system of claim 15, wherein the historical data comprises search logs.
